(19) United States
(12) Patent Application Publication
(10) Pub. No.: US 2025/0119349 A1
(43) Pub. Date: Apr. 10, 2025

(54) METHOD FOR INFORMING NF PLANNED REMOVAL

(71) Applicant: ZTE CORPORATION, Shenzhen (CN)

(72) Inventors: Zhijun LI, Shenzhen (CN); Jinguo ZHU, Shenzhen (CN); Junyi LIU, Shenzhen (CN)

(73) Assignee: ZTE CORPORATION, Shenzhen (CN)

(21) Appl. No.: 18/986,007

(22) Filed: Dec. 18, 2024

Related U.S. Application Data
(63) Continuation of application No. PCT/CN2022/129003, filed on Nov. 1, 2022.

(51) Int. Cl. H04L 41/082

(52) U.S. Cl. CPC H04L 41/082

(57) ABSTRACT

A wireless communication method for use in a first network function (NF) is disclosed. The method comprises transmitting, to a network repository function (NRF), an NF update message comprising planned removal information which indicates a planned removal of the first NF.

This application is a Continuation of PCT Application No. PCT/CN2022/129003, filed Nov. 1, 2022, incorporated herein by reference in its entirety.

### TECHNICAL FIELD

This document is directed generally to wireless communications, and in particular to 5G communications.

### BACKGROUND

In a 5G system, a core network is composed of various virtual network functions (NFs) which provide different services. Among different types of NFs, a special NF named NRF (Network Repository Function) is designed as a central registration node for the various types of NFs. After one NF is deployed in the network and ready to provide services, this NF shall register itself in the NRF for indicating its status as discoverable (which means that the NF is able to be discovered and ready to provide the services). As an alternative, an OAM (operations, administration and maintenance) system may be used to register a batch of NFs to the NRF.

### SUMMARY

Once an NF is registered to the NRF and sets its status to discoverable, other NFs can invoke an NRF service (i.e., discovery service) to discover and select the registered NF and may subsequently subscribe to an NF profile change of that selected NF from the NRF. The NRF then keeps monitoring of the status of the selected NF periodically. If the NRF detects that the selected/monitored NF not reachable for a period, the NRF sets the NF status of that monitored NF to undiscoverable and notifies those NFs subscribing to the NF profile change of that selected/monitored NF.

The NF may request the NRF to update its NF profile in the NRF, e.g., to change its service parameters or set its NF status to undiscoverable. In this case, the NRF sends notifications to all NFs subscribing to the NF profile change of that NF.

This document relates to one method for an NF to inform the NRF and/or other NFs of its planned removal, and thus trigger the reselection of alternative NF to continue the service.

This document relates to methods and devices for continuing services when a planned removal of an NF is needed and in particular to methods and devices for informing a planned removal of an NF and triggering a reselection of alternative NF to continue associated services.

The present disclosure relates to a wireless communication method for use in a first network function (NF). The method comprises transmitting, to a network repository function (NRF), an NF update message comprising planned removal information which indicates a planned removal of the first NF.

Various embodiments may preferably implement the following features:

Preferably or in some embodiments, the planned removal information comprises at least one of: a planned removal indication, or a planned removal time indication.

Preferably or in some embodiments, the planned removal indication comprises an NF status value indicating the planned removal or an indication in an NF profile.

Preferably or in some embodiments, the planned removal time indication indicates the time of the planned removal of the first NF.

Preferably or in some embodiments, the NF update message further comprises a list of alternative NF candidates configured to take over at least one user served by the first NF.

The present disclosure relates to a wireless communication method for use in a network repository function (NRF). The method comprises:
receiving, from a first network function (NF), an NF update message comprising planned removal information which indicates a planned removal of the first NF, and
transmitting, to at least one second NF, a notification message comprising the planed removal information.

Various embodiments may preferably implement the following features:

Preferably or in some embodiments, the wireless communication method further comprises recording the planned removal information in an NF profile of the first NF.

Preferably or in some embodiments, the planned removal information comprises at least one of: a planned removal indication, or a planned removal time indication.

Preferably or in some embodiments, the planned removal indication comprises an NF status value indicating the planned removal or an indication in an NF profile.

Preferably or in some embodiments, the planned removal time indication indicates the time of the planned removal of the first NF.

Preferably or in some embodiments, the notification message further comprises a list of alternative NF candidates configured to take over at least one user served by the first NF.

Preferably or in some embodiments, the list of alternative NF candidates is determined by the NRF.

Preferably or in some embodiments, the NF update message further comprises a list of alternative NF candidates configured to take over at least one user served by the first NF.

Preferably or in some embodiments, the at least one second NF subscribes to an NF status change or an NF profile change of the first NF from the NRF.

The present disclosure relates to a wireless communication method for use in a second network function (NF). The method comprises:
receiving, from a network repository function (NRF), a notification message comprising planed removal information which indicates a planned removal of a first NF, and
selecting at least one alternative NF configured to take over at least one user served by the first NF based on the planed removal information.

Various embodiments may preferably implement the following features:

Preferably or in some embodiments, the planned removal information comprises at least one of: a planned removal indication, or a planned removal time indication.

Preferably or in some embodiments, the planned removal indication comprises an NF status value indicating the planned removal or an indication in an NF profile.

Preferably or in some embodiments, the planned removal time indication indicates the time of the planned removal of the first NF.

Preferably or in some embodiments, the notification message further comprises a list of alternative NF candidates configured to take over at least one user served by the first NF.

Preferably or in some embodiments, selecting the at least one alternative NF configured to take over at least one user served by the first NF based on the planed removal information comprises:
selecting the at least one alternative NF from a list of alternative NF candidates provided by the NRF.

Preferably or in some embodiments, selecting the at least one alternative NF configured to take over at least one user served by the first NF based on the planed removal information comprises:
performing an NF discovery procedure to select the at least one alternative NF.

Preferably or in some embodiments, the wireless communication method further comprises transferring the at least one user served by the first NF to the at least one alternative NF.

Preferably or in some embodiments, the wireless communication method further comprises transferring the at least one user served by the first NF to the at least one alternative NF no later than a removal time.

Preferably or in some embodiments, the removal time is indicated by the planned removal information.

Preferably or in some embodiments, the removal time is determined by the second NF.

Preferably or in some embodiments, the second NF subscribes to an NF status change or an NF profile change of the first NF from the NRF.

The present disclosure relates to a wireless device for a first NF. The wireless device comprises:
a communication unit, configured to transmit to an NRF, an NF update message comprising planned removal information which indicates a planned removal of the first NF.

Various embodiments may preferably implement the following feature:

Preferably or in some embodiments, the wireless device further comprises a processor configured to perform any of aforementioned wireless communication methods.

The present disclosure relates to a wireless device for an NRF. The wireless device comprises:
a communication unit, configured to:
receive, from a first NF, an NF update message comprising planned removal information which indicates a planned removal of the first NF, and
transmit, to at least one second NF, a notification message comprising the planed removal information.

Various embodiments may preferably implement the following feature:

Preferably or in some embodiments, the wireless device further comprises a processor configured to perform any of aforementioned wireless communication methods.

The present disclosure relates to a wireless device for a second NF. The wireless device comprises:
a communication unit, configured to receive, from a network repository function (NRF), a notification message comprising planed removal information which indicates a planned removal of a first NF, and
a processor, configured to select at least one alternative NF configured to take over at least one user served by the first NF based on the planed removal information.

Various embodiments may preferably implement the following feature:

Preferably or in some embodiments, the processor is further configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a network according to an embodiment of the present disclosure.

FIG. 2 shows a schematic diagram of a procedure according to an embodiment of the present disclosure.

FIG. 3 shows a schematic diagram of a procedure according to an embodiment of the present disclosure.

FIG. 4 shows an example of a schematic diagram of a wireless terminal according to an embodiment of the present disclosure.

FIG. 5 shows an example of a schematic diagram of a wireless network node according to an embodiment of the present disclosure.

FIGS. 6 to 8 show flowcharts of methods according to embodiments of the present disclosure.

### DETAILED DESCRIPTION

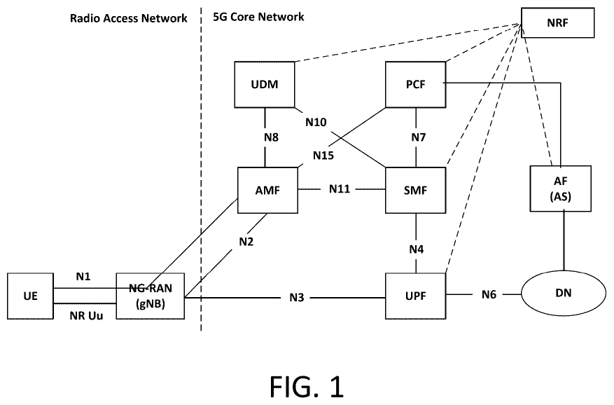

FIG. 1 shows a schematic diagram of a network (architecture) according to an embodiment of the present disclosure. In FIG. 1, there are the following network entities or network functions:
1) UE (User Equipment):
   The UE corresponds to the mobile terminal accessing to a 5G network.
2) NG RAN (Next Generation Radio Access Network).
   In the 5G network, the NG RAN is an NR (new radio) base station, also named as gNB. In an embodiment, the NG RAN may be also called RAN or RAN node.
3) NRF (Network Repository Function):
   The NRF provides a central registration point to all kinds of NFs, and provides NF discovery capability.
4) AMF (Access and Mobility Management function):
   The AMF provides access management and mobility management for the UE, such as registration to network, registration during UE mobility, etc.
5) SMF (Session Management Function):
   The SMF provides PDU session management for the UE, such as IP address allocation, QoS flow setup, etc.
6) UPF (User plane function):
   The UPF provides IP traffic routing and forwarding management.
7) PCF (Policy Control Function)
   The PCF provides QoS policy rules to control plane functions, to enforce the QoS policy rules.
8) AF (Application Function):
   The AF provides instructions to the PCF, to influence the QoS policy rules.

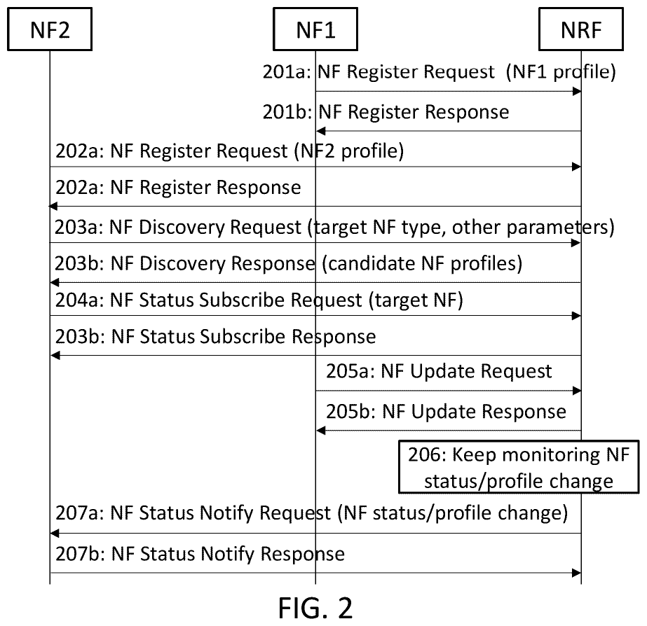

FIG. 2 shows a schematic diagram of a procedure of the subscription and notification of NF status/profile change according to an embodiment of the present disclosure. In FIG. 2, once an NF successfully registers to the NRF, the NF can be discovered by another NF. The NF discovering the registered NF can also subscribe to an NF status/profile change of the registered NF from the NRF. The procedure shown in FIG. 2 comprises the following steps:

Step 201: An NF1 (e.g., SMF) performs an NF Registration procedure with the NRF.

In step 201a, the NF1 sends an NF Register Request to the NRF, wherein the NF Register Request includes the entire NF profile of the NF1. Meanwhile, the NF1 may also include a proposed timer, e.g. a heartbeat timer, in the request message for negotiation. If the request is accepted, the NRF sends an NF Register Response with an accepted (heartbeat) timer in step 201b.

Once the NF1 is successfully registered to the NRF, the NF status of the NF1 is set to “REGISTERED” (e.g., discoverable) in the NRF.

Step 202: Similarly, the NF2 (e.g., AMF) preforms the NF Registration procedure with the NRF in steps 202a and 202b.

Step 203: The NF2 performs an NF Discovery procedure, to select an appropriate NF that can support a service requirement.

Specifically, the NF2 sends a NF Discovery Request to the NRF in step 203a, to indicate a target NF type to be discovered in the request message. The NRF performs a target NF filter (procedure) and sends an NF Discovery Response in step 203b. The response message contains/comprises a list of candidate NFs by providing the NF profile of each candidate NF.

For example, an AMF (i.e., NF2) would like to select a target SMF in step 203. The AMF indicates the target NF type as “SMF” in the request message transmitted to the NRF. The NRF filters out candidate SMFs and returns the candidate NF list to the AMF. The AMF then selects one SMF (e.g., NF1) from the returned candidate NF list.

In this embodiment, the NF2 selects the NF1 from the returned candidate NF list.

Step 204: The NF2 performs an NF status subscribe procedure with the NRF, to subscribe to an NF status change or an NF profile change of the NF1.

For instance, the NF2 sends an NF Status Subscribe Request to the NRF in step 204a, wherein the NF Status Subscribe Request indicates the NF1 as the target NF of the subscription. In step 204b, the NRF accepts the subscription and sends an NF Status Subscribe Response to the NF2.

Step 205: The NF1 performs an NF Registration Update procedure with the NRF, to update the NF status of the NF1 or update the NF service parameters of the NF1.

For example, if the heartbeat timer is to be expired, the NF1 sends an NF Update Request to the NRF in step 205a. The NRF refreshes the heartbeat timer, maintains the status of the NF1, and sends an NF Registration Response in step 205b.

In an embodiment, if the NF1 needs to update the service parameters, the NF1 sends the NF Update Request to the NRF in step 205a, wherein NF Update Request is sent with the updated service parameters or the entire updated NF profile. The NRF accordingly updates the NF profile and sends the NF Update Response in step 205b.

In an embodiment, if the NF1 needs to change the NF status of the NF1 from the previous NF status registered in the NRF to a new NF status, the NF1 sends the NF Update Request to the NRF in step 205a, wherein the NF Update Request is sent with the new NF status. According to the NF Update Request, the NRF updates the NF status in the NF profile of the NF1 and sends the NF Update Response in step 205b. For example, the NF1 may want to quit the service and decides to set its own NF status to “undiscoverable”.

Step 206: The NRF keeps monitoring of the NF status change or NF profile change of the NFs (e.g., NF1) whose NF status/profile change is subscribed by other NFs.

If detecting the NF service parameters update of the monitored NFs, the NRF triggers a notification to those NFs that subscribe to the NF status change of the monitored NFs.

If detecting one NF is no more available (e.g., by checking the periodical heartbeat procedure), the NRF sets the NF status of that NF to “SUSPENDED”. For example, if the NRF does not receive two or three consecutive heartbeats from one NF, the NRF may regard/determine that this NF is now in failure and sets the NF status of the NF to “SUSPENDED”.

Step 207: The NRF sends the notification to the NF2 to inform the NF status change or NF profile change of the NF1.

The NRF sends an NF Status Notify Request to the NF2 in step 207a, wherein the NF Status Notify Request comprises the updated entire NF profile of the NF1 and/or the updated NF service parameters of NF1 (e.g., the updated NF status). The NF2 therefore acknowledges the notification and sends an NF Status Notify Response in step 207b.

If the NF2 (e.g., AMF) acknowledges the NF status of the NF1 (e.g., SMF) is changed (e.g., changed to “SUSPENDED”), the NF2 may trigger another NF discovery procedure to the NRF, to select another proper NF (e.g., another SMF) to continue the service.

The procedure shown in FIG. 2 supports monitoring and notification of the NF service parameter change/update or NF status change (e.g., NF becomes failure, NF determines to quit service). However, the procedure shown in FIG. 2 may not well support a case of NF planned removal. In the present disclosure, the planned removal of an NF represents that the NF is configured to quit services after a configured period or at a specific time. Once the NF announces its planed removal, all existing users served by the NF are expected to be smoothly transferred to other NFs which can provide the equivalent services without causing massive signaling in a short period. Note that, within the configured period for the planned removal or before the specific time of the planned removal, the NF still can serve the existing users served by the NF but does not accept any new user. For one NF to be planned removed, if setting the NF status to “SUSPENDED” as per existing mechanism, other NFs receiving the NF status notification from the NRF will immediately select alternative NFs to transfer users from that NF shown in “SUSPENDED” status. Such immediate transferring of entire users from that NF which is to be planned removed will definitely cause massive signaling to the network in a short period. Thus, the existing mechanism cannot well support the planned removal of one NF.

In an embodiment, the planned removal is also called scheduled removal.

In an embodiment, once an NF is configured/scheduled to have/perform a planned removal (i.e., to quit/end services after a configured period or at a designated/given time), the NF may notify the NRF about the planned removal. The NRF may select an alternative NF and inform related NFs that subscribe to the NF status change of the NF configured to perform the planned removal.

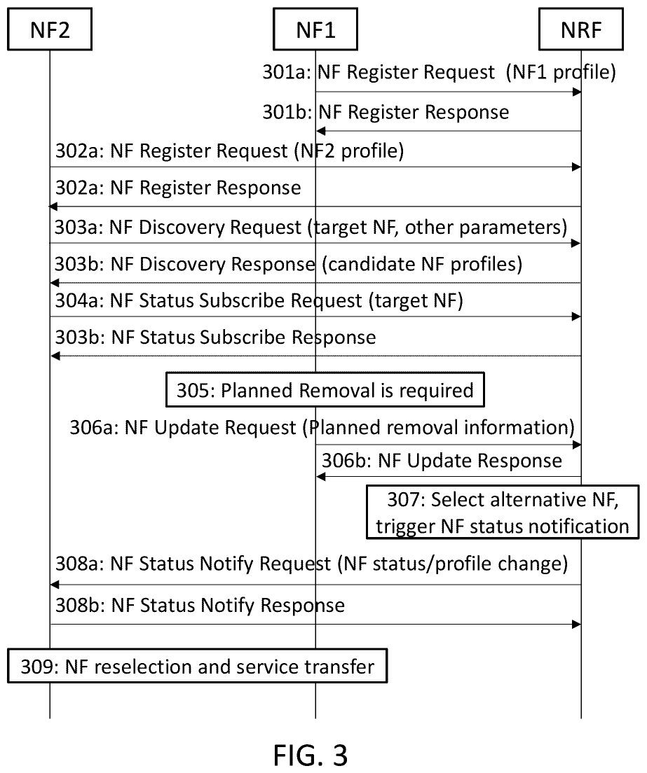

FIG. 3 shows a schematic diagram of a procedure according to an embodiment of the present disclosure. In FIG. 3, the NF configured to perform the planned removal notifies the NRF about the planned removal and an associated notification procedure is accordingly triggered. Specifically, the procedure shown in FIG. 3 comprises the following steps.

Step 301: The NF1 (e.g., SMF) performs an NF Registration procedure with the NRF. The step 301 (i.e., steps 301a and 301b) is similar to step 201 (i.e., step 201a and 201b) shown in FIG. 2.

Step 302: The NF2 (e.g., AMF) also preforms an NF Registration procedure with the NRF. The step 302 (i.e., steps 302a and 302b) can refer to step 202 (i.e., step 202a and 202b) shown in FIG. 2.

Step 303: The NF2 performs an NF Discovery procedure and selects the NF1, which is similar to step 203 (i.e., steps 303a and 303b) shown in FIG. 2.

Step 304: The NF2 performs an NF status subscribe procedure with the NRF, to subscribe to an NF status change or an NF profile change of the NF1. The step 304 (i.e., steps 304a and 304b) can refer to step 204 (i.e., step 204a and 204b) shown in FIG. 2.

Step 305: The NF1 determines that a planned removal is scheduled/needed. That is the NF will quit services after a configured period (e.g., 6 hours) or at a given time (e.g., GMT+8 16:00). Before the configured planned removal, the NF1 is still able to serve the existing users but will not serve any new user. Meanwhile, the NF1 expects that the existing users served by the NF1 will be transferred to other alternative NF(s) smoothly.

Step 306: The NF1 performs an NF Registration Update procedure to the NRF, to indicate the planned removal.

In step 306a, the NF1 sends an NF Update Request to the NRF, wherein the NF Update Request comprises planned removal information (i.e., information of the planned removal). The planned removal information may include at least one of:
(a) a planned removal indication, or
(b) a planned removal time indication.

In an embodiment, the planned removal indication is used/configured to indicate that the NF is scheduled/configured to be removed after certain configured period or at a given time. In an embodiment, the planned removal indication may be an NF status value indicating the planned removal (e.g., “PLANNED_REMOVAL”) or an individual indication comprised in the NF profile.

In an embodiment, the planned removal time indication indicates the time of the planned removal. For example, the planned removal time indication may indicate a planned removal timer. The planned removal is expected to occur when/after the planned removal timer expires. The planned removal timer may be presented as UTC time or a timestamp. As an alternative, the planned removal time indication may indicate a designated/given/specific time of the planned removal. The planned removal is expected to occur at/after the designated/given/specific time. In another embodiment, the planned removal time indication may indicate a planned removal time offset/period. In this embodiment, the planned removal is configured/scheduled to occur the planned removal time offset/period (e.g., 6 hours) after the current time (e.g., the time of transmitting/receiving the NF Update request carrying the planned removal information).

In addition, in the NF Update Request transmitted in step 306a, the NF1 may further include a list of alternative NFs which are able to take over the users served by the NF1.

In step 306b, the NRF acknowledges the planned removal of the NF1, records the planned removal information in the NF profile of the NF1, and sends an NF Update Response to the NF1.

Step 307: When/After receiving the planned removal information from the NF1 in step 306, the NRF selects alternative NFs and determines to trigger a notification to each of the related NFs that have subscribed to the NF status change of the NF1.

If the NF1 indicates/transmits the alternative NFs in step 306, the NRF may directly take the indicated alternative NFs as selected alternative NFs. As an alternative or in addition, the NRF may check the NF profile of the NF1 to get the possible alternative NFs (e.g., backup NFs registered in the NF profile and/or NFs belonging to the same NF Set).

Step 308: The NRF sends a notification to the NF2 to inform the planned removal of the NF1.

In step 308a, the NRF sends an NF Status Notify Request to the NF2, wherein the NF Status Notify Request comprises the planned removal information of the NF1. The planned removal information of NF1 may be comprised in the updated NF profile of the NF1 or be presented as individual information outside of the NF profile.

The planned removal information may include at least one of:
(a) a planned removal indication, or
(b) a planned removal time indication.

In an embodiment, the planned removal indication is used/configured to indicate that the NF is scheduled/configured to be removed after certain configured period or at a given time. In an embodiment, the planned removal indication may be an NF status value indicating the planned removal (e.g., “PLANNED_REMOVAL”) or an individual indication comprised in the NF profile.

In an embodiment, the planned removal time indication indicates the time of the planned removal. For example, the planned removal time indication may indicate a planned removal timer. The planned removal is expected to occur when/after the planned removal timer expires. The planned removal timer may be presented as UTC time or a timestamp. As an alternative, the planned removal time indication may indicate a designated/given/specific time of the planned removal. The planned removal is expected to occur at/after the designated/given/specific time. In another embodiment, the planned removal time indication may indicate a planned removal time offset/period. In this embodiment, the planned removal is configured/scheduled to occur the planned removal time offset/period (e.g., 6 hours) after the current time (e.g., the time of transmitting/receiving the NF Update request carrying the planned removal information).

Acknowledging the planned removal information of the NF1, the NF2 sends an NF Status Notification Response to the NRF.

Step 309: After/When the NF2 acknowledges the planned removal information of the NF1, the NF2 may reselect alternative NF(s) to transfer the user to the new NF, so as to continue the services.

In an embodiment of the NF Status Notify message in step 308 includes the list of alternative NFs (e.g., SMF), the NF2 selects one from the list of alternative NFs as the alternative NF and transfers the impacted users (i.e., the users served by the NF1) to the selected alternative NF. If no alternative NF is indicated in step 308, the NF2 may initiate an individual NF discovery to the NRF to find alternative NF(s).

In an embodiment of the planned removal time indication being provided in step 308, the user transfer shall be scheduled before the indicated planned removal time indicated by the planned removal time indication. Because the number of impacted users (i.e., users served by the NF1) may be huge, the user transfer can be appropriately scheduled to avoid huge signaling overhead in a short period. In an embodiment, if no explicit planned removal time indication provided in step 308, the NF2 may determine an appropriate planned removal time based on, e.g., local policy, to smoothly transfer the impacted users from the to be planned removed NF to other alternative NFs.

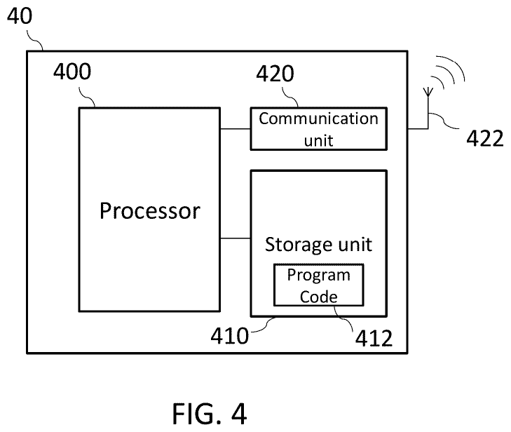

FIG. 4 relates to a schematic diagram of a wireless terminal 40 according to an embodiment of the present disclosure. The wireless terminal 40 may be a user equipment (UE), a mobile phone, a laptop, a tablet computer, an electronic book or a portable computer system and is not limited herein. The wireless terminal 40 may include a processor 400 such as a microprocessor or Application Specific Integrated Circuit (ASIC), a storage unit 410 and a communication unit 420. The storage unit 410 may be any data storage device that stores a program code 412, which is accessed and executed by the processor 400. Embodiments of the storage unit 410 include but are not limited to a subscriber identity module (SIM), read-only memory (ROM), flash memory, random-access memory (RAM), hard-disk, and optical data storage device. The communication unit 420 may a transceiver and is used to transmit and receive signals (e.g., messages or packets) according to processing results of the processor 400. In an embodiment, the communication unit 420 transmits and receives the signals via at least one antenna 422 shown in FIG. 4.

In an embodiment, the storage unit 410 and the program code 412 may be omitted and the processor 400 may include a storage unit with stored program code.

The processor 400 may implement any one of the steps in exemplified embodiments on the wireless terminal 40, e.g., by executing the program code 412.

The communication unit 420 may be a transceiver. The communication unit 420 may as an alternative or in addition be combining a transmitting unit and a receiving unit configured to transmit and to receive, respectively, signals to and from a wireless network node (e.g., a base station).

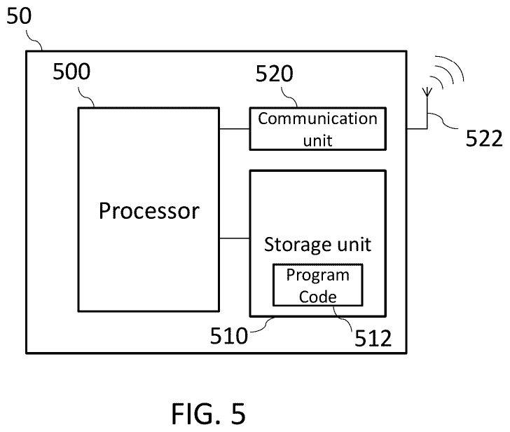

FIG. 5 relates to a schematic diagram of a wireless network node 50 according to an embodiment of the present disclosure. The wireless network node 50 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 50 may comprise (perform) at least one network function such as an access and mobility management function (AMF), a session management function (SMF), a user place function (UPF), a policy control function (PCF), an application function (AF), etc. The wireless network node 50 may include a processor 500 such as a microprocessor or ASIC, a storage unit 510 and a communication unit 520. The storage unit 510 may be any data storage device that stores a program code 512, which is accessed and executed by the processor 500. Examples of the storage unit 510 include but are not limited to a SIM, ROM, flash memory, RAM, hard-disk, and optical data storage device. The communication unit 520 may be a transceiver and is used to transmit and receive signals (e.g., messages or packets) according to processing results of the processor 500. In an example, the communication unit 520 transmits and receives the signals via at least one antenna 522 shown in FIG. 5.

In an embodiment, the storage unit 510 and the program code 512 may be omitted. The processor 500 may include a storage unit with stored program code.

The processor 500 may implement any steps described in exemplified embodiments on the wireless network node 50, e.g., via executing the program code 512.

The communication unit 520 may be a transceiver. The communication unit 520 may as an alternative or in addition be combining a transmitting unit and a receiving unit configured to transmit and to receive, respectively, signals to and from a wireless terminal (e.g., a user equipment or another wireless network node).

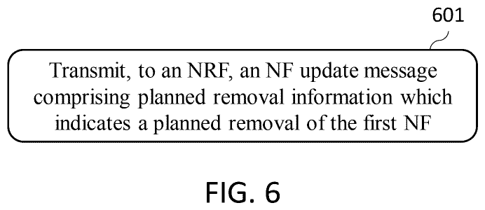

FIG. 6 shows a flowchart of a method according to an embodiment of the present disclosure. The method shown in FIG. 6 may be used in a first NF and comprises the following step:

Step 601: Transmit, to an NRF, an NF update message comprising planned removal information which indicates a planned removal of the first NF.

In FIG. 6, the first NF may be scheduled/configured to quit/stop services and/or to perform a planned removal. For example, the first NF may determine that the planned removal is needed/required/configured/scheduled. The first NF then transmits an NF update message to the NRF, wherein the NF update message comprises planned removal information (i.e., information of the planned removal), e.g., to inform the NRF of the planned removal.

In an embodiment, the planned removal information comprises a planned removal indication and/or a planned removal time indication.

In an embodiment, the planned removal indication may include an NF status value indicating the planned removal (e.g., “PLANNED REMOVAL”) or an indication in an NF profile.

In an embodiment, the planned removal time indication indicates the time of the planned removal. For example, the planned removal time indication indicates the time of the planned removal (being performed or occurring) by indicating a planned removal timer which may be presented in UTC time or a time stamp. The planned removal (is expected to) occurs when/after the expiry of the planned removal timer. As an alternative, the planned removal time indication may indicate a designated/given/specific time (e.g., a UTC time) of the planned removal. The planned removal is expected to occur at/after the designated/given/specific time. As another alternative, the planned removal time indication may indicate a planned removal time offset/period. In this embodiment, the planned removal is configured/scheduled to occur the planned removal time offset/period (e.g., 6 hours) after the current time (e.g., the time of transmitting/receiving the NF Update request carrying the planned removal information).

In an embodiment, the first NF may further include a list of alternative NF candidates in the NF update message or transmit a list of alternative NF candidates along with the NF update message. The list of alternative NF candidates indicates the NF(s) configured to take over at least one user served by the first NF.

In an embodiment, the first NF may be/comprise at least one of an SMF, an SMSF (short message service function) or a PCF.

In an embodiment, the method shown in FIG. 6 may be used/performed by a wireless device comprising/for the first NF. The wireless device comprising the first NF refers to a wireless device performing at least part of functionalities of the first NF.

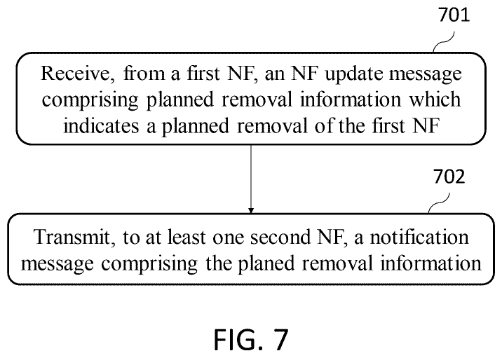

FIG. 7 shows a flowchart of a method according to an embodiment of the present disclosure. The method shown in FIG. 7 may be used in an NRF (e.g., a wireless device comprising/for the NRF or a wireless device performing at least part of functionalities of the NRF) and comprises the following steps:

Step 701: Receive, from a first NF, an NF update message comprising planned removal information which indicates a planned removal of the first NF.

Step 702: Transmit, to at least one second NF, a notification message comprising the planed removal information.

In FIG. 7, the NRF receives an NF update message from a first NF. The NF update message comprises planned removal information which indicates a planned removal of the first NF. The NRF then transmits a notification message comprising the planed removal information to at least one second NF, e.g., to inform the at least one second NF of the planned removal of the first NF.

In an embodiment, the NRF records the planned removal information in the NF profile of the first NF after receiving the NF update message.

In an embodiment, the planned removal information comprises a planned removal indication and/or a planned removal time indication.

In an embodiment, the planned removal indication may include an NF status value indicating the planned removal (e.g., “PLANNED REMOVAL”) or an indication in an NF profile.

In an embodiment, the planned removal time indication indicates the time of the planned removal. For example, the planned removal time indication indicates the time of the planned removal (being performed or occurring) by indicating a planned removal timer which may be presented in UTC time or a time stamp. The planned removal (is expected to) occurs when/after the expiry of the planned removal timer. As an alternative, the planned removal time indication may indicate a designated/given/specific time (e.g., a UTC time) of the planned removal. The planned removal is expected to occur at/after the designated/given/specific time. As another alternative, the planned removal time indication may indicate a planned removal time offset/period. In this embodiment, the planned removal is configured/scheduled to occur the planned removal time offset/period (e.g., 6 hours) after the current time (e.g., the time of transmitting/receiving the NF Update request carrying the planned removal information).

In an embodiment, the notification message may further comprise a list of alternative NF candidates configured to take over at least one user served by the first NF. In an embodiment, the list of alternative NF candidates may be determined by the NRF. As an alternative or in addition, the list of alternative NF candidates is received from the first NF (e.g., in the NF update message).

In an embodiment, each second NF may subscribe to an NF status change or an NF profile change of the first NF from the NRF. That is the notification message may be (comprised in) an NF Status Notify Request (see, e.g., Step 308a).

In an embodiment, the first NF may be be/comprise at least one of an SMF, an SMSF (short message service function) or a PCF.

In an embodiment, the second NF may be/comprise at least one of an AMF or an SMF.

For example, the first NF may be an SMF or an SMSF and the second NF may be an AMF. As an alternative, the first NF may be a PCF and the second NF may be an AMF or an SMF.

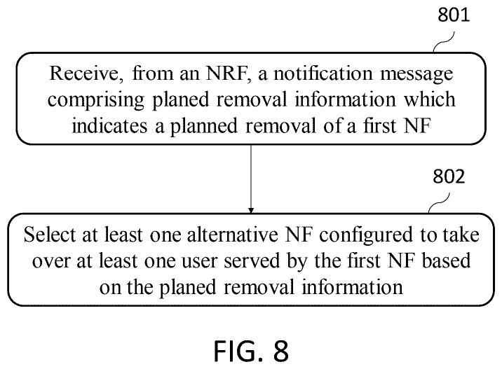

FIG. 8 shows a flowchart of a method according to an embodiment of the present disclosure. The method shown in FIG. 8 may be used in a second NF (e.g., a wireless device comprising/for the second NF, or a wireless device performing at least part of functionalities of the second NF) and comprises the following steps:

Step 801: Receive, from an NRF, a notification message comprising planed removal information which indicates a planned removal of a first NF.

Step 802: Select at least one alternative NF configured to take over at least one user served by the first NF based on the planed removal information.

In FIG. 8, the second NF receives a notification message from an NRF. The notification message comprises planed removal information which indicates a planned removal of a first NF. In response to/Based on the planed removal information, the second NF selects at least one alternative NF used/configured to take over at least one user (e.g., UE, wireless terminal, mobile device) served by the first NF based on the planed removal information.

In an embodiment, the planned removal information comprises a planned removal indication and/or a planned removal time indication.

In an embodiment, the planned removal indication may include an NF status value indicating the planned removal (e.g., “PLANNED REMOVAL”) or an indication in an NF profile.

In an embodiment, the planned removal time indication indicates the time of the planned removal. For example, the planned removal time indication indicates the time of the planned removal (being performed or occurring) by indicating a planned removal timer which may be presented in UTC time or a time stamp. The planned removal (is expected to) occurs when/after the expiry of the planned removal timer. As an alternative, the planned removal time indication may indicate a designated/given/specific time (e.g., a UTC time) of the planned removal. The planned removal is expected to occur at/after the designated/given/specific time. As another alternative, the planned removal time indication may indicate a planned removal time offset/period. In this embodiment, the planned removal is configured/scheduled to occur the planned removal time offset/period (e.g., 6 hours) after the current time (e.g., the time of transmitting/receiving the NF Update request carrying the planned removal information).

In an embodiment, the second NF may determine a planned removal time for the first NF. In this embodiment, the notification message may not comprise the planned removal indication.

In an embodiment, the notification message further comprises a list of alternative NF candidates configured to take over at least one user served by the first NF. The second NF therefore can select the alternative NF(s) from the list of alternative NF candidates (provided by/received from the NRF).

In an embodiment, the second NF may perform an NF discovery procedure to select the alternative NF(s) (see, e.g., steps 203a and 203b). In this embodiment, the NRF may not provide the list of alternative NF candidates for the selection of the alternative NF(s).

In an embodiment, after selecting the alternative NF(s), the second NF transfers the at least one user served by the first NF to the selected alternative NF(s). For example, the transfer may be completed no later than (i.e., before or at) the time of the planned removal of the first NF. Note that the time of the planned removal may be indicated by the planned removal time indication in the notification message or determined by the second NF.

In an embodiment, the method further comprises subscribing to an NF status change or an NF profile change of the first NF from the NRF (see, e.g., steps 204a and 204b). That is the notification message may be (included in) an NF Status Notify Request indicating an NF profile/status change associated with the first NF. For example, the first NF may be an SMF or an SMSF and the second NF may be an AMF. As an alternative, the first NF may be a PCF and the second NF may be an AMF or an SMF.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a first network function (NF), the wireless communication method comprising:
transmitting, to a network repository function (NRF), an NF update message comprising planned removal information which indicates a planned removal of the first NF.

2. The wireless communication method of claim 1, wherein the planned removal information comprises at least one of:
a planned removal indication, or
a planned removal time indication,
wherein the planned removal indication comprises an NF status value indicating the planned removal or an indication in an NF profile, or
wherein the planned removal time indication indicates the time of the planned removal of the first NF.

3. The wireless communication method of claim 1, wherein the NF update message further comprises a list of alternative NF candidates configured to take over at least one user served by the first NF.

4. A wireless communication method for use in a network repository function (NRF), the wireless communication method comprising:
receiving, from a first network function (NF), an NF update message comprising planned removal information which indicates a planned removal of the first NF, and
transmitting, to at least one second NF, a notification message comprising the planned removal information.

5. The wireless communication method of claim 4, further comprising:
recording the planned removal information in an NF profile of the first NF.

6. The wireless communication method of claim 4, wherein the planned removal information comprises at least one of:
a planned removal indication, or
a planned removal time indication,
wherein the planned removal indication comprises an NF status value indicating the planned removal or an indication in a network function profile, or
wherein the planned removal time indication indicates the time of the planned removal of the first NF.

7. The wireless communication method of claim 4, wherein the notification message further comprises a list of alternative NF candidates configured to take over at least one user served by the first NF.

8. The wireless communication method of claim 7, wherein the list of alternative NF candidates is determined by the NRF.

9. The wireless communication method of claim 4, wherein the NF update message further comprises a list of alternative NF candidates configured to take over at least one user served by the first NF.

10. The wireless communication method of claim 4, wherein the at least one second NF subscribes to an NF status change or an NF profile change of the first NF from the NRF.

11. A wireless communication method for use in a second network function (NF), the wireless communication method comprising:
receiving, from a network repository function (NRF), a notification message comprising planned removal information which indicates a planned removal of a first NF, and
selecting at least one alternative NF configured to take over at least one user served by the first NF based on the planned removal information.

12. The wireless communication method of claim 11, wherein the planned removal information comprises at least one of:
a planned removal indication, or
a planned removal time indication,
wherein the planned removal indication comprises an NF status value indicating the planned removal or an indication in a network function profile, or
wherein the planned removal time indication indicates the time of the planned removal of the first NF.

13. The wireless communication method of claim 11, wherein the notification message further comprises a list of alternative NF candidates configured to take over at least one user served by the first NF.

14. The wireless communication method of claim 11, wherein selecting the at least one alternative NF configured to take over at least one user served by the first NF based on the planned removal information comprises:
selecting the at least one alternative NF from a list of alternative NF candidates provided by the NRF, or
performing an NF discovery procedure to select the at least one alternative NF.

15. The wireless communication method of claim 11, further comprising:
transferring the at least one user served by the first NF to the at least one alternative NF.

16. The wireless communication method of claim 15, wherein transferring the at least one user served by the first NF to the at least one alternative NF comprises:
transferring the at least one user served by the first NF to the at least one alternative NF no later than a removal time indicated by the planned removal information.

17. The wireless communication method of claim 11, wherein the second NF subscribes to an NF status change or an NF profile change of the first NF from the NRF.

18. A wireless device for a first network function (NF), the wireless device comprising:
a communication unit, configured to execute the wireless communication method according to claim 1.

19. A wireless device for a network repository function (NRF), the wireless device comprising:
a communication unit, configured to execute the wireless communication method according to claim 4.

20. A wireless device for a second network function (NF), the wireless device comprising a communication unit and a processor configured to execute the wireless communication method of claim 11.
